(19) United States
(12) Patent Application Publication
(10) Pub. No.: US 2007/0006009 A1
(43) Pub. Date: Jan. 4, 2007

(54) Methods and apparatus for aligning data

(75) Inventors: Scott Douglas Clark, Rochester, MN (US); Kerry Christopher Imming, Rochester, MN (US); Ibrahim Abdel-Rahman Ouda, Rochester, MN (US)

Correspondence Address: Leslie J. Payne, Attorney;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 11/171,782

(22) Filed: Jun. 30, 2005

(51) Int. Cl. G06F 1/12

(52) U.S. Cl. 713/400

(57) ABSTRACT

In a first aspect, a first method is provided for aligning data. The first method includes the steps of (1) transmitting identical reference data from first logic to second logic on each of a plurality of busses coupling the first logic to the second logic; (2) determining values indicative of time skews among the busses; and (3) configuring alignment logic based on the values such that the alignment logic aligns the reference data received from each of the plurality of busses. Numerous other aspects are provided.

### FIELD OF THE INVENTION

The present invention relates generally to computer systems, and more particularly to methods and apparatus for aligning data.

### BACKGROUND

In conventional systems, data may be transmitted on each of a plurality of busses coupling a first chip to a second chip. For various reasons, such as delays caused by wiring differences between the busses (e.g., on a circuit board) and/or clocking differences between the chips, respective data transmitted on the busses at the same time may arrive at the first or second chip at different times. In such instances, the received data may require alignment. Accordingly, methods and apparatus for aligning data are desired.

### SUMMARY OF THE INVENTION

In a first aspect of the invention, a first method is provided for aligning data. The first method includes the steps of (1) transmitting identical reference data from first logic to second logic on each of a plurality of busses coupling the first logic to the second logic; (2) determining values indicative of time skews among the busses; and (3) configuring alignment logic based on the values such that the alignment logic aligns the reference data received from each of the plurality of busses.

In a second aspect of the invention, a second method is provided for aligning data. The second method includes the steps of (1) transmitting reference data from first logic to second logic on a bus coupling the first logic to the second logic; (2) determining a value indicative of a time delay associated with the bus; and (3) configuring alignment logic based on the value such that the alignment logic aligns the reference data received from the bus.

In a third aspect of the invention, a first apparatus is provided for aligning data. The first apparatus includes (1) first logic; (2) second logic; (3) a plurality of busses coupling the first logic and second logic; and (4) alignment logic coupled to the first and second logic. The apparatus is adapted to, after identical reference data is transmitted from the first logic to the second logic on each of the plurality of busses (a) determine values indicative of time skews among the busses; and (b) configure the alignment logic based on the values such that the alignment logic aligns the reference data received from each of the plurality of busses.

In a fourth aspect of the invention, a first system is provided for aligning data. The first system includes (1) a processor; (2) a memory; and (3) a circuit board for aligning data coupled to the processor and memory. The circuit board has (a) a source integrated circuit (IC); (b) a destination IC; (c) a plurality of busses coupling the source IC and destination IC; and (d) aligning logic coupled to the source and destination ICs. The system is adapted to, after identical reference data is transmitted from the source IC to the destination IC on each of the plurality of busses, determine values indicative of time skews among the busses and configure the alignment logic based on the values such that the alignment logic aligns the reference data received from each of the plurality of busses. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for aligning data in accordance with an embodiment of the present invention.

FIG. 2 is a block diagram of shift logic included in the system for aligning data in accordance with an embodiment of the present invention.

FIG. 3 is a block diagram of an exemplary data structure adapted to store data received from a bus included in the system for aligning data in accordance with an embodiment of the present invention.

FIG. 4 illustrates a method of aligning data in accordance with an embodiment of the present invention.

### DETAILED DESCRIPTION

The present invention provides methods and apparatus for transmitting data between logic components (e.g., integrated circuits (ICs) or chips) of a system, which may include and/or be coupled to a circuit board (e.g., printed circuit board (PCB) or card), using a plurality of busses, which form respective links between the logic components. For example, data may be transmitted from a first chip and received by a second chip using four busses (e.g., one-byte wide data busses). For various reasons, such as delays caused by PCB wiring differences between the busses and/or clocking differences between the chips, respective data transmitted on the busses at the same time by the first chip may arrive at the second chip at different times. Therefore, the received data may require alignment.

The present invention provides methods and apparatus for configuring (or training) a system including a set of chips to transfer data between the chips so that the data is aligned automatically. During configuration, skew between busses of the system may be measured and reference values for configuring logic to accommodate such skew during subsequent transfers of actual data may be determined. For example, during configuration, the same reference data may be transmitted serially on each of the busses from the first chip to the second chip. The reference data may include a symbol (e.g., a bit pattern) indicating a start of the reference data. While receiving data from a bus, the second chip may employ a deserializer to deserialize the received byte data into words (e.g., eight byte words), and may detect the symbol. However, the detected symbol may not be properly aligned in the deserialized data (e.g., aligned as the first portion of a word output by the deserializer) due to the above noted different transmission times. Therefore, if necessary, the present invention may shift the deserialized data using shift logic such that the symbol is aligned as the first portion of a word. More specifically, the shift logic may combine a plurality of deserialized data words to form a word in which the symbol is properly aligned. In this manner, the present invention may shift the position of the symbol, and determine a state required by the shift logic (shift logic state) (e.g., a multiplexer control signal) to shift the symbol in this manner that can be later used for automatically aligning actual data.

Alternatively or additionally, during configuration, the system may synchronize reference data received in the second chip from the busses. More specifically, respective data received from the busses may be stored in corresponding queues (e.g., four, eight byte-wide queues) such that a word (e.g., eight bytes), which includes the symbol (e.g., as the first portion of the word), may be read from each of the queues at the same time (e.g., during the same cycle). Therefore, the system may shift reference data transmitted on a bus relative to reference data transmitted on remaining busses. A queues state (e.g., respective starting locations of data available to be read from the queues) required to store and read data from the queues in the manner above may be determined. In this manner, the present invention may configure the system to transfer data between the logic components and automatically adjust for any differences in transmission times between the busses. In other words, once configured, the system may employ the reference values (e.g., shift logic state and queues state) determined during the configuration to align and synchronize actual data (e.g., non-reference data) transmitted between chips using the busses.

The system may include logic, such as control logic and respective registers in the first and second chips. The control logic, other card hardware and/or software may be employed to set bit values in the registers during configuration such that the shift logic state and the queues state may be stored once determined and then used for adjusting actual data.

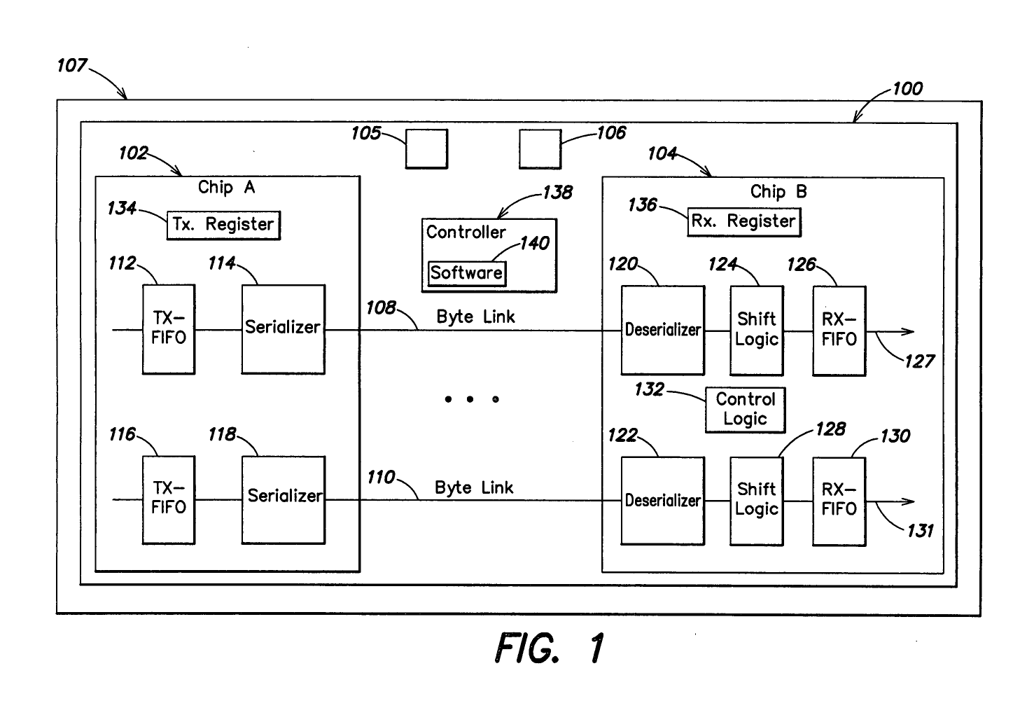

FIG. 1 is a block diagram of a system for aligning data in accordance with an embodiment of the present invention. With reference to FIG. 1, the system 100 may include a plurality of integrated circuits (ICs) such as a first chip 102 and a second chip 104. The system 100 may be, for example, a printed circuit board (e.g., a card to which the ICs are coupled), which may have memory 105 and a processor 106 coupled thereto. The system 100 may be adapted to couple to a computer 107 or another suitable device.

The first chip 102 may be coupled to the second chip 104 via a plurality of busses 108, 110, each of which forms a link, between the chips 102, 104. In one embodiment, two busses may couple the first chip 102 to the second chip 104. Each of the plurality of busses 108, 110 may be byte-wide busses (although the busses 108, 110 may be larger or smaller). Therefore, each of the busses 108, 110 may be adapted to transmit one byte of data at a time.

The first chip 102 may include a first data structure 112 (e.g., a transmit first in first out queue (FIFO)) adapted to store data to be transmitted from the first chip 102 coupled to the first bus 108 via first serializing logic 114 (e.g., a first serializer). The first serializing logic 114 may be adapted to receive data (e.g., bytes of data) in parallel and to serially output the data on the first bus 108. Similarly, the first chip 102 may include a second data structure 116 (e.g., a transmit FIFO) adapted to store data to be transmitted from the first chip 102 coupled to the second bus 110 via second serializing logic 118 (e.g., a second serializer). The second serializing logic 118 may be adapted to receive data (e.g., bytes of data) in parallel and to serially output the data on the second bus 110. Transmit FIFOs and serializing logic may be coupled to remaining busses of the system in a similar manner.

The second chip 104 may include first deserializing logic 120 coupled to the first bus 108 and adapted to receive serial data (e.g., bytes of data serially) and output the data in parallel (e.g., a plurality of bytes during a clock cycle). Similarly, the second chip 104 may include second deserializing logic 122 coupled to the second bus 110 and adapted to receive serial data and output parallel data. Due to differences in wiring lengths of the plurality of busses 108, 110 (e.g., on the system 100) and/or clocking differences of the plurality of ICs (e.g., the first and second chips 102, 104), data (e.g., identical data) transmitted from the first and second busses 108, 110 at the same time may not be received by the first and second deserializers 120, 122, respectively, at the same time. Therefore, such data may not be output from the first and second deserializers 120, 122 at the same time.

The second chip 104 may include first shift logic 124 coupled to an output of the first deserializer 120. The first shift logic 124 may be adapted to receive data output from the first deserializer 120, for example, during a first and second clock cycles, merge such received data into words and output such words. The first shift logic 124 may form words such that a desired portion of data received by the first logic 124 is included as a first portion of a word formed and output by the first shift logic 124. The second chip 104 may include a first data structure 126 (e.g., a receive FIFO queue) adapted to store data received from the first chip 102 via the first bus 108. An output 127 of the first data structure 126 of the second chip 104 may serve as a first output of the system 100.

Similarly, the second chip 104 may include second shift logic 128 coupled to an output of the second deserializer 122. The second shift logic 128 may be adapted to receive data output from the second deserializer 122, for example, during a first and second clock cycles, merge such received data into words and output such words. The second shift logic 128 may form words such that a desired portion of data received by the second shift logic 128 is included as a first portion of a word formed and output by the second shift logic 128. The second chip 104 may include a second data structure 130 (e.g., a receive FIFO) adapted to store data received from the first chip 102 via the second bus 110. An output 131 of the second data structure 130 of the second chip 104 may serve as a second output of the system 100. In a similar manner, deserializing logic, shift logic and data structures may couple to remaining busses, respectively.

The system 100 may include control logic 132 adapted to provide a control signal to the shift logic (e.g., the first and/or second shift logic 124, 128) that affects the manner in which the shift logic 124, 128 merges data. Further, the control logic 132 may store information describing data structures, such as the first and second data structures 126, 130 (e.g., receive FIFOs). For example, the control logic 132 may control read and write pointers for the first and second data structures 126, 130, respectively.

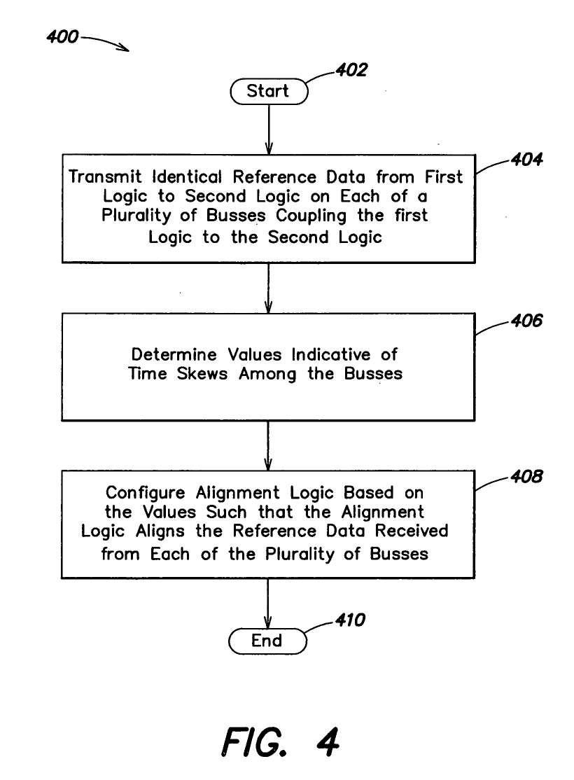

The first chip 102 may include a first register 134 (e.g., a transmit register) adapted to store bits (e.g., a state) that control operation of the system 100. Similarly, the second chip 104 may include a second register 136 (e.g., a receive register) adapted to store bits (e.g., a state) that control operation of the system 100. The system 100 may include a controller 138 adapted to execute software 140 and set one or more bits in the first and/or second registers 134, 136 and thereby control operation of the system 100. During operation, hardware (e.g., control logic 132, shift logic 124, 128, first data structure 126, second data structure 130, etc.) included in the system 100 may also set one or more bits in the first and/or second register 134, 136 and thereby control operation of the system 100. Logic of the system such as the control logic 132, shift logic 124, 128, data structures 126, 130 and/or registers 134, 136 may serve as alignment logic. Details of operation of the system 100 are described below with reference to FIG. 4.

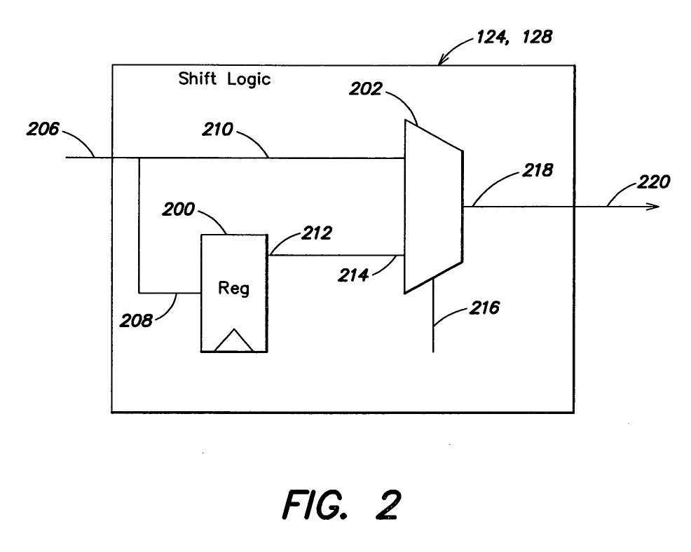

FIG. 2 is a block diagram of shift logic included in the system for aligning data in accordance with an embodiment of the present invention. With reference to FIG. 2, the shift logic 124, 128 may include a shift logic register 200 coupled to a multiplexer 202. More specifically, an input 206 of the shift logic 124, 128 may be coupled to an input 208 of the shift logic register 200 and a first input 210 of the multiplexer 202. An output 212 of the shift logic register 200 may be coupled to a second input 214 of the multiplexer 202. A third input 216 of the multiplexer 202 may be coupled to the control logic (132 in FIG. 1). The multiplexer 202 may be adapted to selectively merge data received by the first input 210 and a shifted version of data received by the second input based on a signal (e.g., a control signal) received by the third input 216, and selectively output such merged data (e.g., via a multiplexer output 218). The multiplexer output 218 may serve as an output 220 of the shift logic 124, 128. Although the shift register logic input 208, shift register logic output 212, first multiplexer input 210, second multiplexer input 214 and multiplexer output 218 are represented as a single input, the inputs and outputs 208, 210, 212, 214, 218 may represent a plurality of inputs and outputs, respectively, such that data may be input in parallel to and/or output in parallel from the shift logic register 200 and the multiplexer 202.

For example, during a first clock cycle, a first set of data (e.g., eight bytes of data) may be received by the shift logic input 206 and applied to the first input 210 of the multiplexer 202 and the input 208 of the shift logic register 200 in parallel. During a subsequent clock cycle (e.g., a second clock cycle), a second set of data (e.g., eight bytes of data) may be received by the shift logic input 206 and applied to the first input 210 of the multiplexer 202 and the input 208 of the shift logic register 200 in parallel. Also, during the subsequent clock cycle, the shift logic register 200 may output the first set of data, and therefore, the first set of data may be input by the multiplexer 202, via the second input 214. Based on a control signal input by the multiplexer 202 via the third input 216, the multiplexer may output a word (e.g., an eight byte word). For example, the multiplexer 202 may merge a shifted version of the first set of data with the second set of data based on the control signal such that a new word is formed by and output from the multiplexer 202. The control signal applied to the third input 216 of the multiplexer 202 may be selected such that a selected byte included in the first set of data is the most significant byte of the new word. In this manner, the shift logic 124, 128 may output a set of data (e.g., an eight byte word) such that the selected byte is left-aligned in the set of data. The control logic 132 may be adapted to monitor data received by the shift logic 124, 128 (e.g., for the selected byte) and output a control signal to the multiplexer 202 such that the multiplexer 202 outputs a set of data including the selected byte positioned as described above.

The shift logic 124, 128 described above is exemplary, and therefore, the shift logic 124, 128 may be configured differently. For example, a larger or smaller amount of and/or different logic may be employed. Although the shift logic 124, 128 (and logic 200, 202 included therein) is described above as inputting eight bytes of data at a time via an input and outputting eight bytes of data at a time via an output, in some embodiments, the shift logic 124, 128 may input and/or output larger or smaller number of bytes at a time.

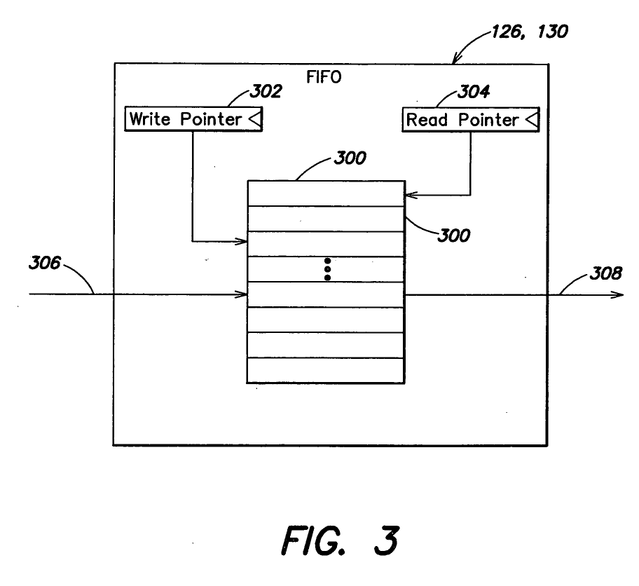

FIG. 3 is a block diagram of an exemplary data structure adapted to store data received from a bus included in the system for aligning data in accordance with an embodiment of the present invention. With reference to FIG. 3, the exemplary data structure (e.g., a receive FIFO queue) 126, 130 adapted to store data received from the first chip (102 in FIG. 1) via a bus (108, 110 in FIG. 1) may be a circular queue. In some embodiments, the exemplary data structure 126, 130 may include twelve eight-byte wide entries 300. Although the exemplary data structure 126, 130 may include a larger or smaller number of entries. Further, each entry in the exemplary data structure 126, 130 may be of a larger or smaller width. For example, each entry 300 in the exemplary data structure 126, 130 may be four bytes wide. The exemplary data structure 126, 130 may include or be associated with information describing the exemplary data structure 126, 130. For example, the exemplary data structure 126, 130 may include or be associated with a write pointer 302 indicating an entry 300 of the data structure 126; 130 to which data may be written. Similarly, the exemplary data structure 126, 130 may include or be associated with a read pointer 304 indicating an entry 300 of the data structure 126, 130 from which data may be read.

For example, data received by the data structure 126, 130 via an input 306 during a first clock cycle may be written to the entry 300 indicated by the write pointer 302. Data received by the data structure 126, 130 via the input 306 during a subsequent clock cycle may be written to the entry 300 indicated by the write pointer 302 at that time, which may be the same entry written to during the first clock cycle or a different (e.g., a next available) entry. Alignment may be performed by writing data to the entry indicated by the write pointer 302, and not advancing the write pointer 302 until the first byte of the reference data is received, thereby overwriting data previously stored in the entry indicated by the write pointer 302.

Similarly, during a first clock cycle, data stored by the data structure 126, 130 may be read from an entry 300 indicated by the read pointer 304. Data read in this manner may be output from the data structure 126, 130 via an output 308 of the data structure 126, 130. During a subsequent clock cycle data may be read from the entry 300 indicated by the read pointer, which may be the same entry read from during the first clock cycle or a different (e.g., a next) entry. Read pointers 304 associated with each data structure 126, 130 may start advancing once all data structures 126, 130 have received and stored the first byte of the reference data. In this manner, the write pointers may be employed to align the data. Data may be read from the same read pointer in all data structures 126, 130 after all write pointers have started to advance.

The control logic (132 in FIG. 1) may monitor data received by the data structure 126, 130 (e.g., for data including the selected byte) and control information included in the write and/or read pointer, thereby controlling a position of the write and/or read pointer.

The operation of the system 100 for aligning data is now described with reference to FIGS. 1-3 and with reference to FIG. 4 which illustrates a method of aligning data in accordance with an embodiment of the present invention. With reference to FIG. 4, in step 402, the method 400 begins. In step 404, identical reference data may be transmitted from first logic to second logic on each of a plurality of busses coupling the first logic to the second logic. The reference data may serve as a pattern to train the system 100 how to align data received from the plurality of busses 108, 110. For example, the same reference data may repeatedly be sent from the first chip 102 to the second chip 104 on each of the plurality of busses 108, 110. In some embodiments, the reference data may include a first symbol or bit pattern (e.g., byte), such as 0xEE, indicating the start of the reference data followed by a plurality of (e.g., seventy-one) repeated bytes (e.g., 0x00). However, the reference data may include a larger or smaller number of bytes and/or different bytes.

For each bus 108, 110, data output by the transmit data structure 112, 116 (e.g., in parallel) may be input by the serializing logic 114, 118 coupled thereto. The serializing logic 114, 118 may serialize the reference data and output the serialized data on the bus 108, 110 coupled thereto.

The identical reference data transmitted on the plurality of busses 108, 110 may be received by deserializing logic 120, 122 coupled thereto. Because of delays caused by wiring differences between the busses 108, 110 (e.g., on the circuit board) and/or clocking differences between the chips 102, 104, for example, respective data transmitted on the busses 108, 110 at the same time may arrive at corresponding deserializing logic 120, 122 of the second chip 104 at different times. Therefore, the first deserializing logic 120 coupled to the first bus 108 may output data to the first shift logic 124 coupled thereto at a different time than the second deserializing logic 122 outputs data to the second shift logic 128 coupled thereto.

Initially, the first register 134 may store one or more bits forming a first state of the first register 134. Similarly, the second register 136 may store one or more bits forming a first state of the second register 136. To initiate the transmission of identical reference data on each of the plurality of busses 108, 110, the controller 138 (e.g., software 140 executed thereby) may set one or more bits in the second register 136 to form a second state of the second register 136. While the second register 136 stores the second state, system hardware, such as the control logic 132, may begin monitoring data received by the shift logic 124, 128 and/or the first and second data structures 126, 130 for the reference data (e.g., for the first symbol of the reference data). Further, the controller 138 (e.g., software 140 executed thereby) may set one or more bits in the first register 134 to form a second state of the first register 134. While the first register 134 stores the second state, the identical reference data may be transmitted from the first chip 102 to the second chip 104 on each of a plurality of busses 108, 110 coupling the first chip 102 to the second chip 104.

In step 406, values indicative of time skews among the busses may be determined. More specifically, a queues state may be determined and stored by the system 100. The queues state may be positions of the write and/or read pointers 302, 304 for the first and second data structures 126, 130 adapted to store data received by the second chip 104 such that data read from the first and second data structures 126, 130 may be aligned. For example, the control logic 132 may monitor data received by and stored in the first and second data structures 126, 130 for the first byte (symbol) of the reference data. The read and write pointers 302, 304 may point to the same entry 300 in a data structure 126, 130 as data is stored in the data structure 126, 130 until the control logic 132 detects the first byte of the reference data has been received (and stored) by the data structure 126, 130. Thereafter, the write pointer 302 of the data structure 126, 130 may increment (e.g., to a next entry 300) after data is stored in the data structure 126, 130. In this manner, the control logic 132 may determine how to position the read pointers 304 associated with the data structure 126, 130 so that a set of data (e.g., a word) including the first byte of the reference data may be read from each data structure 126, 130 at the same time. Consequently, data received by the second chip 104 via the plurality of busses 108, 110 may be synchronized. More specifically, the data received from the plurality of busses 108, 110 may be aligned with each other.

Additionally, a shift logic state may be determined and stored by the system 100. The shift logic state may be respective control signals applied to the shift logic 124, 128 of the system 100 during training to align the data. For example, the control logic 132 may monitor the reference data received by the first and/or second shift logic 124, 128 and determine control signals that should be applied to multiplexers 202 therein, respectively, such that the first byte of the reference data is included as a first portion (e.g., the most significant bits) of data (e.g., a set of bytes) output from the shift logic 124, 128. In this manner, data received by the second chip 104 via a bus 108, 110 may be shifted such that the first byte of the reference data is included as the first portion of a word output by the shift logic, and thereby data received via the bus 108, 110 is aligned.

In step 408, alignment logic may be configured based on the values such that the alignment logic aligns the reference data received from each of the plurality of busses. More specifically, the queues state determined by the control logic 132 may be employed to store reference data received by the second chip 104 via the plurality of busses 108, 110 into respective data structures 126, 130 so that the read pointer 304 of each data structure 126, 130 points to an entry 300 therein storing data (e.g., a word) including the first byte of the reference data.

Additionally, the shift logic state determined by the control logic 132 may be employed to provide respective control signals to multiplexers 202 included in the shift logic 124, 128 to align data received by the second chip 104 from a bus 108, 110 in the manner described above. In this manner, data, which includes the first byte of the reference data as the first portion (e.g., the most significant bits), may be output from each of the data structures 126, 130 at the same time.

For example, while the first and second registers 134, 136 store respective second states, the control logic 132 may determine and employ the shift logic state to configure the shift logic 124, 128 so that data received by the second chip 104 via each bus 108, 110 is appropriately shifted, and thereby aligned. Once the shift logic 124, 128 has aligned data received by the second chip 104 via each bus 108, 110, system hardware (e.g., the control logic 132) may set one or more bits in the second register 136 to form a third state of the second register 136. The controller 138 (e.g., software 140 executed thereby) may poll the second register 136 for the third state to determine whether data received by the second chip 104 via each bus 108, 110 has been properly aligned.

While the first register 134 stores the second state and the second register 136 stores the third state, the control logic 132 may determine and employ the queues state to configure the data structures 126, 130 so that data received by the second chip 104 via the plurality of busses 108, 110 and stored as entries 300 in respective data structures 126, 130 may be read from such data structures 126, 130 in the manner described above, and thereby synchronized. Once respective data stored in the data structures 126, 130 is synchronized, system hardware (e.g., the control logic 132) may set one or more bits in the second register 136 to form a fourth state of the second register 136. The controller 138 (e.g., software executed thereby) may poll the second register 136 for the fourth state to determine whether data received by the second chip 104 via the plurality of busses 108, 110 has been synchronized, and thereby aligned.

Once the controller 138 determines the second register 136 stores the fourth state, the controller 138 (e.g., software executed thereby) may reset one or more bits stored by the first register 134 so that the first register 134 stores a third state. While the first register 134 stores the third state and the second register 136 stores the fourth state, the first chip 102 may stop repeatedly transmitting the reference data to the second chip 104.

Thereafter, the controller 138 (e.g., software executed thereby) may reset one or more bits stored by the second register 136 so that the second register 136 stores a fifth state. While the first register 134 stores the third state and the second register 136 stores the fifth state, system hardware (e.g., the control logic 132) may stop monitoring respective data received by the second chip 104 via the plurality of busses 108, 110 for the first byte of the reference data. In this manner, the system 100 may be trained to transfer data between the first chip 102 and second chip 104 using a plurality of busses 108, 110 such that the data transmitted on the plurality of busses 108, 110 may be aligned. Although a specific sequence of register states is described above to train the system 100, a different sequence of register states may be employed.

Thereafter, step 410 may be performed. In step 410, the method 400 ends.

Additionally, once the system 100 has been trained to align data, actual data may be transmitted from the first chip 102 to the second chip 104 via the plurality of busses 108, 110 such that the data is automatically aligned. More specifically, the queues state may be employed to configure the data structures 126, 130 and/or the shift logic state may be employed to configure the shift logic 124, 128 such that actual data transmitted between the first chip 102 and second chip 104 via the plurality of busses 108, 110 is automatically aligned. Consequently, in contrast to conventional systems, a user may not have calculate and manually insert delays into the system to align data transmitted from the first chip 102 to the second chip 104 via the plurality of busses 108, 110.

Through use of the method 400 of FIG. 4, a system 100 may be trained to automatically synchronize (e.g., to the same clock pulse) data transmitted from a first IC to a second IC via a plurality of busses. In this manner, the system may account for data transmission delays caused by wiring differences between the busses (e.g., on a circuit board), clocking differences between the chips, etc. For example, during training, the system 100 may learn an appropriate amount by which data received from one or more of the busses 108, 110 should be shifted. The shift amount may remain constant, and therefore, such shift amount may be employed to automatically align data subsequently transmitted from the first IC to the second IC of the system 100.

The foregoing description discloses only exemplary embodiments of the invention. Modifications of the above disclosed apparatus and methods which fall within the scope of the invention will be readily apparent to those of ordinary skill in the art. For instance, the system 100 includes a plurality of busses 108, 110 coupled to the data structures 126, 130 via shift logic 124, 128. Therefore, shift logic 124, 128 may shift and merge data received from a bus 108, 110, thereby aligning data (in the manner described above) before the data structures 126, 130 are employed to synchronize data receive from the plurality of busses 108, 110. Alternatively, in some embodiments, the system 100 may include shift logic 124, 128 coupled to the plurality of busses 108, 110 via the data structures 126, 130. In such embodiments, the data structures 126, 130 may synchronize the data received via the plurality of busses 108, 110, and thereafter, the shift logic 124, 128 may shift and merge data (in the manner described above), thereby aligning the data output from a corresponding data structure 126, 130.

In some embodiments, in addition to coupling to the second chip 104 via a plurality of busses 108, 110, the first chip 102 may couple to a third chip (not shown) via a plurality of busses. Similar to the second chip, the third chip may be adapted align data received from the first chip 102 via the plurality of busses. Further, the shift logic 124, 128 of the present invention may be employed in a system including a first chip coupled to a second chip via a single bus. In such systems, the shift logic 124, 128 may shift and merge data (in the manner described above), thereby aligning data received by the second chip via the bus. In this manner, such systems may accommodate for a delay associated with the bus. Additionally, in some embodiments, the data structures 126, 130 may be adapted to add latency (e.g., one or more cycles of latency) to the bus. In this manner, a data structure 126, 130 may simulate an effect of having additional card wiring delay, for example, during a test mode. Alternatively or additionally, in some embodiments, the system 100 may include a mode in which the alignment function (e.g., performed by the shift logic 124, 128) may be bypassed, for example, during a system test or debug mode. Although the control logic 132 is shown as a single component, in some embodiments, the system 100 may include first control logic adapted to determine the shift logic state and control the shift logic, and second control logic adapted to determine the queues state and control the data structures 126, 130.

Accordingly, while the present invention has been disclosed in connection with exemplary embodiments thereof, it should be understood that other embodiments may fall within the spirit and scope of the invention, as defined by the following claims.

The invention claimed is:

1. A method of aligning data, comprising:
transmitting identical reference data from first logic to second logic on each of a plurality of busses coupling the first logic to the second logic;
determining values indicative of time skews among the busses; and
configuring alignment logic based on the values such that the alignment logic aligns the reference data received from each of the plurality of busses.

2. The method of claim 1 further comprising employing the values to automatically align actual data transmitted using the plurality of busses from the first logic to the second logic.

3. The method of claim 1 further comprising storing data received by the second logic from the plurality of busses in respective queues;
wherein determining values indicative of time skews among the busses includes determining a queues state, the queues state indicating a starting location of data available to be read from each of the queues.

4. The method of claim 3 wherein configuring alignment logic based on the values such that the alignment logic aligns the reference data received from each of the plurality of busses includes employing the queues state to set a read pointer indicating a starting location of data available to be read from a queue for each of the queues.

5. The method of claim 3 wherein determining values indicative of time skews among the busses further includes determining how to align reference data received by the second logic from a bus such that a start of the reference data is a first portion of a word formed from one or more portions of the reference data.

6. The method of claim 5 wherein determining how to align reference data received by the second logic from a bus such that a start of the reference data is a first portion of a word formed from one or more portions of the reference data includes determining control signals for shift logic that cause the shift logic to form a word from one or more portions of the received reference data such that a first portion of the word is the start of the reference data.

7. The method of claim 6 wherein configuring alignment logic based on the values such that the alignment logic aligns the reference data received from each of the plurality of busses includes employing the shift logic control signals to form a word from one or more portions of the received reference data such that a first portion of the word is the start of the reference data.

8. An apparatus for aligning data, comprising:
first logic;
second logic;
a plurality of busses coupling the first logic and second logic; and
alignment logic coupled to the first and second logic;
wherein the apparatus is adapted to:
after identical reference data is transmitted from the first logic to the second logic on each of the plurality of busses,
determine values indicative of time skews among the busses; and
configure the alignment logic based on the values such that the alignment logic aligns the reference data received from each of the plurality of busses.

9. The apparatus of claim 8 wherein the apparatus is further adapted to employ the values to automatically align actual data transmitted using the plurality of busses from the first logic to the second logic.

10. The apparatus of claim 8 wherein the apparatus is further adapted to:
store data received by the second logic from the plurality of busses in respective queues; and
determine a queues state, the queues state indicating a starting location of data available to be read from each of the queues.

11. The apparatus of claim 10 wherein the apparatus is further adapted to employ the queues state to set a read pointer indicating a starting location of data available to be read from a queue for each of the queues.

12. The apparatus of claim 10 wherein the apparatus is further adapted to determine how to align reference data received by the second logic from a bus such that a start of the reference data is a first portion of a word formed from one or more portions of the reference data.

13. The apparatus of claim 12 wherein the apparatus is further adapted to determine control signals for shift logic that cause the shift logic to form a word from one or more portions of the received reference data such that a first portion of the word is the start of the reference data.

14. The apparatus of claim 13 wherein the apparatus is further adapted to employ the shift logic control signals to form a word from one or more portions of the received reference data such that a first portion of the word is the start of the reference data.

15. A system for aligning data, comprising:
a processor;
a memory; and
a circuit board for aligning data, coupled to the processor and memory, and having:
a source integrated circuit (IC);
a destination IC;
a plurality of busses coupling the source IC and destination IC; and
aligning logic coupled to the source and destination ICs;
wherein the system is adapted to:
after identical reference data is transmitted from the source IC to the destination IC on each of the plurality of busses,
determine values indicative of time skews among the busses; and
configure the alignment logic based on the values such that the alignment logic aligns the reference data received from each of the plurality of busses.

16. The system of claim 15 wherein the system is further adapted to employ the values to automatically align actual data transmitted using the plurality of busses from the source IC to the destination IC.

17. The system of claim 15 wherein the system is further adapted to:
store data received by the destination IC from the plurality of busses in respective queues; and
determine a queues state, the queues state indicating a starting location of data available to be read from each of the queues.

18. The system of claim 17 wherein the system is further adapted to employ the queues state to set a read pointer indicating a starting location of data available to be read from a queue for each of the queues.

19. The system of claim 17 wherein the system is further adapted to determine how to align reference data received by the destination IC from a bus such that a start of the reference data is a first portion of a word formed from one or more portions of the reference data.

20. The system of claim 19 wherein the system is further adapted to:
determine control signals for the aligning logic that cause the aligning logic to form a word from one or more portions of the received reference data such that a first portion of the word is the start of the reference data; and
employ the aligning logic control signals to form a word from one or more portions of the received reference data such that a first portion of the word is the start of the reference data.

21. A method of aligning data, comprising:
transmitting reference data from first logic to second logic on a bus coupling the first logic to the second logic;
determining a value indicative of a time delay associated with the bus; and
configuring alignment logic based on the value such that the alignment logic aligns the reference data received from the bus.

22. The method of claim 21 further comprising employing the value to automatically align actual data transmitted using the bus from the first logic to the second logic.
